(19) United States
(12) Patent Application Publication
(10) Pub. No.: US 2025/0253781 A1
(43) Pub. Date: Aug. 7, 2025

(54) CONTROLLER FOR ELECTRIC MOTOR-DRIVEN ROTATING-BLADE COMMINUTION AND MIXING

(71) Applicant: BLADE GRINDER TECHNOLOGIES LLC, College Station, TX (US)

(72) Inventors: William H. MARLOW, College Station, TX (US); Eric D. LAIRD, Bryan, TX (US)

(21) Appl. No.: 18/856,834

(22) PCT Filed: Apr. 17, 2023
(86) PCT No.: PCT/US2023/018824

§ 371 Date: Oct. 14, 2024

Related U.S. Application Data
(60) Provisional application No. 63/331,580, filed on Apr. 15, 2022.

(51) Int. Cl. H02P 6/15; A47J 42/26; A47J 42/28; A47J 42/46

(52) U.S. Cl. CPC H02P 6/153; A47J 42/26; A47J 42/28; A47J 42/46

(57) ABSTRACT

A coffee grinder is provided that includes one or more blades; a motor coupled to the one or more blades to drive rotation of the one or blades; and a grind controller that receives a supply voltage; receives a grind setting corresponding to a particular particle distribution; and controls RMS voltage, duty cycle, activation pulse frequency, and overall duration of a grind time of the supply voltage for activation of the motor based on the grind setting, wherein the grind controller generates, from the supply voltage, an adjusted voltage signal of a constant RMS voltage that is supplied to the motor during activation pulses occurring during the overall duration of the grind time to complete operation of the grind setting.

### BACKGROUND

Field of Application. This invention relates to control of electric motors to produce modal grind distributions using blade grinders and the mixing of granular materials. The methods and approaches described herein can be applied to achieve a grind-product size distribution with a single, dominant mode from batch grinding of one or more materials. For example, the methods described herein are suitable for batch grinding, or comminution, of roasted coffee beans for brewing of coffee beverage as well as for effective mixing and blending of various granular materials.

The following, brief, background discussion will facilitate the subsequent description of the invention. The way that the amount, or masses, of particles varies among the different particle sizes of a grind is called its size, or mass, distribution. For example, grinding of coffee beans for coffee beverage brewing produces a distribution of particle sizes ranging from the “ultrafines and dusts” at the smallest-size end of the distribution (typically smaller than 0.6 mm nominal diameter as determined by sieving) to the “coarse” particles at the largest end (typically 1 to 2 mm determined similarly). Certain characteristics of the size distribution, in addition to bean properties including their roast, can contribute to the ability to obtain a preferred flavor in brewing a coffee beverage. For example, a single, predominant size range or mode of the mass distribution is often sought with other properties of the size distribution differing and dependent upon the method of brewing coffee, such as French (or European) press, percolation, drip, espresso or high-pressure extractions, and others. Since comminution methods produce ultrafines and dusts that are not desirable for most brewing methods other than espresso, minimizing this finest component of the size distribution of the grind is also sought. Even for espresso, control of the ultrafines is desirable. Another consideration of coffee grinding is the avoidance of heating during the grinding process.

Currently, there are three general methods that are available for coffee grinding: roller grinding, rotating blade grinding, and burr-type grinding, or more generally methods relying upon the rotation of closely-spaced, patterned surfaces whose separation determines the maximum size of ground particle. Roller-grinding is a continuous throughput method used primarily for very large, commercial-scale grinding operations and is sometimes credited with producing the best size distributions for all grind size distributions. The rotating blade grinder is probably the most widely used small-batch grind method in domestic use because of its small size, low purchase price, and low cost of ownership due to its durability. However, the rotating blade grinder is generally considered to provide very poor size distributions of ground particles. Burr-type grinders are used in scenarios with continuous throughput. Burr-type grinders are characterized by rotating, closely-spaced surfaces of various configurations and are widely employed for domestic as well as small or moderate quantity commercial uses. Such grinders are generally credited with providing adequate to very good size distributions. However, the initial cost of a reliable and durable burr-type grinder is considerably higher than for the rotating blade grinder. In addition, heating of the grinding surfaces and, therefore, the grounds, when used continuously can be an issue with burr-type grinders. The operational requirements of burr-type grinders can also limit their lifespan, leading ultimately to high ownership costs.

### BRIEF SUMMARY OF THE INVENTION

Controllers for electric motors that drive rotating blade comminution and mixing are provided.

A grind controller for a rotating blade coffee grinder is provided that can optimize the grind size distributions for particular brewing methods and coffee roasts by controlling multiple operational parameters of the rotating blade coffee grinder. Such a grind controller can receive a supply voltage; receive a grind setting corresponding to a particular particle distribution; and control RMS voltage, duty cycle, activation pulse frequency, and overall duration of a grind time of the supply voltage for activation of the motor based on the grind setting. The grind controller generates, from the supply voltage, an adjusted voltage signal that is supplied to the motor during activation pulses occurring during the overall duration of the grind time to complete operation of the grind setting. The adjusted voltage signal provides a constant RMS voltage that is less than a line-in voltage of the supply voltage. Length of time for each activation pulse and timing between activation pulses are optimized for providing sufficient time to disrupt/relax laminar flow of the particulate material being ground while keeping overall duration of the grind within desired time constraints. For example, each activation pulse has a pulse length less than five seconds; and, in certain implementations the pulse length of each activation pulse is less than one second.

The rotating blade coffee grinder has one or more blades that are coupled to a motor that drives their rotation when suitable voltage is delivered to the motor. The grind controller is coupled between a supply voltage and the motor of the rotating blade coffee grinder to generate an adjusted voltage signal and control the motor in a manner that achieves desirable grind size distributions. The controller may be implemented either as external circuitry to the grinder, built internally into the electronics of the grinder, or may be part of the control system for a partially or fully automated coffee brewing system or system that otherwise involves grinding of coffee beans.

A method of operating a rotating blade grinder comprising a motor coupled to one or more blades includes reading an input voltage of a supply voltage; receiving a grind setting corresponding to a particular particle distribution; creating an output correction including activation pulses and timing data based on the input voltage and the grind setting; and performing pulse width modulation of the supply voltage to output an adjusted voltage signal for a specified duration of grind time according to the output correction such that for each activation of a motor of the rotating blade grinder caused by a corresponding activation pulse of the activation pulses during the specified duration of the grind time, the adjusted voltage signal has a constant RMS voltage. The constant RMS voltage can be maintained by using the timing data to delay an amount of time from each zero crossing of the supply voltage before allowing the supply voltage to be output to a load.

A grind controller includes a processing element and memory with instructions to perform the above method of operating a rotating blade grinder. In some cases, the grind controller includes an AC zero crossing detector coupled to receive the supply voltage; an AC voltage meter coupled to receive the supply voltage; a user interface controller coupled to receive the grind setting and an output of the AC voltage meter, the user interface controller creating an output correction including timing data and activation pulses based on the output of the AC voltage meter and the grind setting; a pulse width controller coupled to receive the output correction from the user interface controller and a zero crossing signal of the AC zero crossing detector; and an AC switch coupled to receive the supply voltage and output an adjusted voltage signal under control of the pulse width controller.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1A illustrates an example configuration of a rotating blade comminution system for a coffee grinder with an external controller.

FIG. 1B illustrates an example configuration of a rotating blade comminution system for a coffee grinder with an internal controller.

FIG. 1C is a representational diagram of a rotating blade comminution system for a coffee grinder with remote.

FIG. 2A is a block diagram of a controller for electric motor-driven rotating-blade comminution and mixing.

FIG. 2B illustrates a method of operating a rotating blade grinder for performing electric motor-driven rotating blade comminution for a desired grind setting.

FIG. 3A illustrates an example operation of the pulse width modulation controller shown in FIG. 2A for performing electric motor-driven rotating blade comminution for a desired grind setting.

FIG. 3B shows a timing diagram of an example output of the pulse width modulation controller.

FIG. 4 is a histogram graph of grinds size distributions from an unmodified grinder for two grind time intervals.

FIG. 5 is a histogram of medium roast coffee size distributions ground with a controller for Drip and French Press brewing methods.

FIG. 6 is a histogram comparing Standard North American Coffee Norms for Drip grind and a Drip grind obtained using the controller described herein.

### DETAILED DESCRIPTION

Controllers for electric motors that drive rotating blade comminution and mixing are provided. Modal grind distribution by rotating blade comminution is described. In addition, the described techniques are suitable for mixing granular materials. Existing inexpensive and durable rotating blade coffee grinders produce coffee grounds that brew coffee beverages of disappointing quality, even with the manufacturers' limited controls on the operation of their grinders. This result is attributed to the size distributions of the grounds that differ greatly from the published Standard North American Coffee Norms for grinds' mass distributions that herein serve as benchmarks for the various brewing methods. In themselves, these published size distributions reflect the extraction kinetics for coffee grinds in water in consideration of the conditions imposed by the various brewing methods. Through the described controllers and methods it is possible to optimize the grind size distribution produced by a rotating blade grinder according to these benchmarks for each of a variety of brewing methods and coffee roasts by controlling multiple operational parameters of this grinder.

In general, for rotating blade coffee grinding technology, the blade rotates at a single, very high rate, in the range of 20,000 to 40,000 revolutions per minute (rpm) or more (rates without grinding load), depending upon manufacturer and model. Most rotating blade coffee grinders operate between 25,000 rpm and 35,000 rpm. For appliances used for mixing granular materials, the rates of rotation are lower. The electric motor driving the blade is powered at a line voltage, such as, but not limited to, the United States standard 120 Volts, rms, at 60 cycles per second. The rotating blades of coffee grinders are intended originally to operate continuously and without interruption during the grind process, though manual interruptions and termination of the power to the blades are possible. In the coffee grinding process, high densities of coffee particles moving under the influence of the rotating blade appear to form a rotating fluidized bed of ground coffee wherein the collective behavior of the coffee bed governs particle motion and particle exposure to the moving blade.

On the individual collision level, fracture of a solid particle due to collision with the spinning blade results in particle size reduction that is believed always to produce two types of products: (1) two or possibly more particles, usually of roughly similar sizes (i.e., within an order of magnitude); (2) ultrafine particles and dusts that are thought to be ejected from sharp or pointed edges and small prominences of the newly-fractured particles as they re-form to more stable (e.g., smoother) configurations. The energy, imparted by the rotating blade to the original material to cause the fracturing, is dissipated in part by generating these products. In practice, the presence of excessive fractions of ultrafine coffee particles and dusts is often cited in evaluations of coffee grinders as one of the highly undesirable characteristics of coffee grinds produced by rotating blade grinders.

One of the challenges with rotating blade coffee grinders is their production of broad, poorly defined size distributions of ground coffee particles with little or no evident mode. Presumably, this is due to the repeated and indiscriminate grinding of the fluidized bed of coffee grinds due to the blade motion. The modern understanding of optimal grinds for different brewing methods requires different corresponding size distributions of coffee particles wherein the largest fractions of the ground coffee are concentrated in the vicinity of a characteristic size, or mode, of the distribution with the distribution of larger and smaller particles dependent upon the brewing method. A related observation that is also a minor criticism of current rotating blade coffee grinders is the presence within the fluidized bed of one or a very small number of unground or minimally ground coffee beans that persist throughout the grinding process, despite earlier identification of manually interrupting operation of the grinder motor as a means of avoiding this phenomenon.

Another challenge with the rotating blade grinder is its tendency to heat the grind if it is operated continuously for too long a period of time on a particular charge of beans.

Through the inclusion of a controller as described herein, one can (1) significantly reduce the ultrafine particles and dusts fraction of the grind's size distribution, (2) produce grind particle size distributions with a single, well-defined mode with no unground or minimally ground particles, and (3) reduce the heating of the grinds during the grinding process. The methods for achieving these improvements include reductions to specified levels of voltages to the grinder motor resulting in the lowering of the ultimate rotational frequency, regular interruptions of voltage to grinder motor during the course of a grind, and specified durations of grind.

The described controller of a rotating blade coffee grinder may be employed on the input power line of a conventional grinder, built by design into its internal electronics and controls, or as a component of instrumentation that employs a rotating blade grinder (such as part of the control system for a partially or fully automated coffee brewing system or other system that otherwise involves grinding of coffee beans). For the external controller module, the male power plug for the grinder can connect to the corresponding receptacle in the controller packaging while the controller itself has a power cord that plugs into the power source receptacle, i.e., the normal line source.

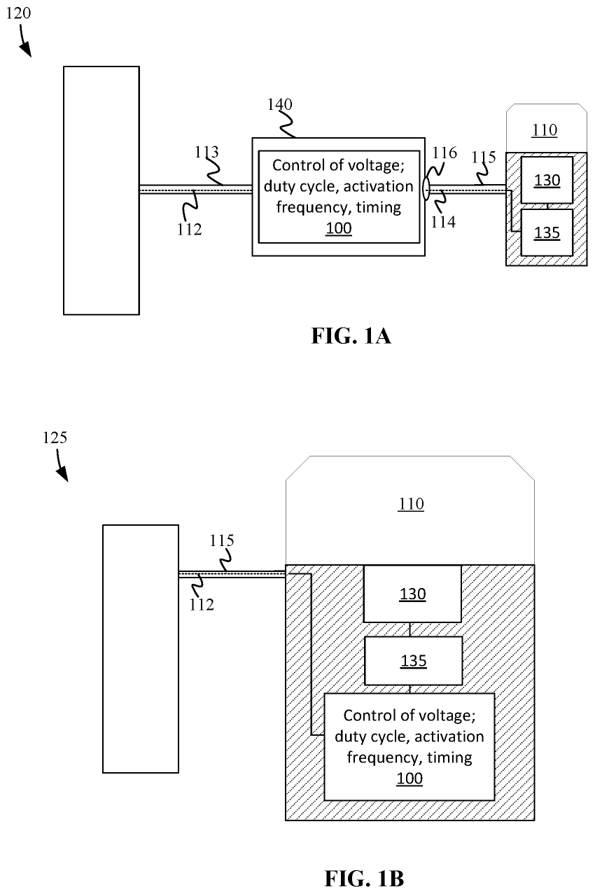

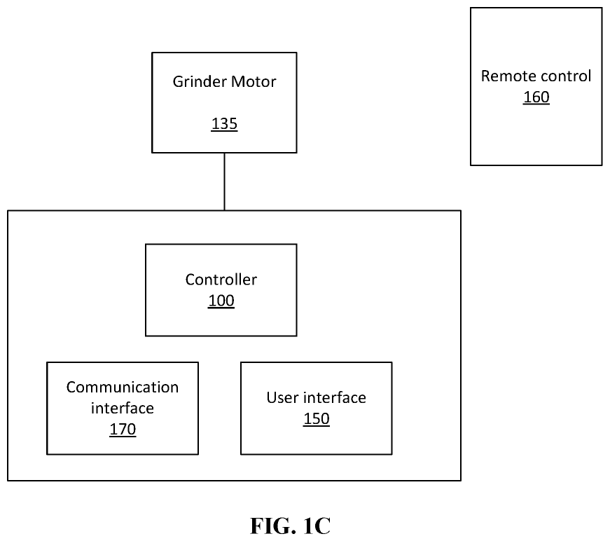

FIG. 1A illustrates an example configuration of a rotating blade comminution system for a coffee grinder with an external controller; FIG. 1B illustrates an example configuration of a rotating blade comminution system for a coffee grinder with an internal controller; and FIG. 1C is a representational diagram of user interface capabilities of a rotating blade comminution system for a coffee grinder.

Referring to FIGS. 1A and 1B, a rotating blade comminution system for a coffee grinder includes a controller 100 and components of a rotating blade coffee grinder 110. The rotating blade coffee grinder 110 can include one or more blades 130 and a motor 135 coupled to the one or more blades 130 to drive rotation of the one or more blades. In some cases, the one or more blades 130 are mounted to an axis of rotation where a plane of rotation of the one or more blades 130 is perpendicular to the axis of rotation. The blades 130 can have various shapes, including straight, sickle, or curved. In various implementations, no paddle blades are used. In some cases, the rotating blade coffee grinder 110 includes a grind chamber that confines particles (e.g., coffee beans) on all sides. The controller 100 receives a supply voltage; receives a grind setting corresponding to a particular particle distribution; and controls RMS voltage, duty cycle, activation pulse frequency, and overall duration of a grind time of the supply voltage for activation of the motor based on the grind setting.

Referring to FIG. 1A, the controller 100 of the rotating blade comminution system 120 is in a controller package 140 external to the rotating blade coffee grinder 110. The controller package 140 includes a package power cord 113 and an outlet 116 shaped to receive a plug connector of a power cord 115 of the rotating blade coffee grinder 110. The controller 100 can receive a supply voltage 112 through the package power cord 113 and supply an adjusted voltage signal 114 through the power cord 115 to the motor 135 of the rotating blade coffee grinder 110.

Referring to FIG. 1B, the controller 100 of the rotating blade comminution system 125 is internal to the rotating blade coffee grinder 110. The controller 100 receives supply voltage 112 via the power cord 115 of the rotating blade coffee grinder 110 and supplies the adjusted voltage signal to the motor 135 of the rotating blade coffee grinder 110.

Referring to FIG. 1C, controller 100 can receive a grind setting corresponding to a particular particle distribution in a variety of ways. In some cases, the grind settings are received through a user interface 150 for direct (either on a controller package or via the coffee grinder package) selection by a user of a setting. In some cases, the grind settings are received through communications capabilities (e.g., hardware providing Bluetooth, Wi-Fi, near field communication, or wireless communication) that enables communication with a remote device 160 via a communication interface 170. The remote device 160 can be a computing device such as a smartphone running an application that is used to communicate and control the controller/grinder.

Referring to FIGS. 1A-1C, based on the received inputs, the controller 100 controls RMS voltage, duty cycle, activation pulse frequency, and overall duration of a grind time of the supply voltage for activation of the motor 135 based on the grind setting. That is, the controller 100 is provided to modify the supply, or line current (and corresponding rms voltage or “line voltage”), to control the motor 135 of the rotating blade coffee grinder 110. Controller 100 is coupled to receive the supply voltage 112 and is coupled to output an adjusted voltage signal of the supply voltage to the motor 135 of the rotating blade coffee grinder 110. The controller can receive supply voltage (e.g., supply voltage 112), a grind setting corresponding to a particular particle distribution (e.g., sizes for espresso, drip, etc.), and control RMS voltage, duty cycle, activation pulse frequency, and overall duration of a grind time of the supply voltage for activation of the motor 135. The grind controller generates, from the supply voltage, an adjusted voltage signal 114 that is supplied to the motor during activation pulses occurring during the overall duration of the grind time to complete operation of the grind setting. The adjusted voltage signal 114 provides a constant RMS voltage that is less than the line-in voltage of the supply voltage. Length of time for each activation pulse and timing between activation pulses are optimized for providing sufficient time to disrupt/relax laminar flow of the material being ground while keeping overall duration of the grind within desired time constraints. For example, each activation pulse has a pulse length less than five seconds; and, in certain implementations the pulse length of each activation pulse is less than one second.

The controller 100 can determine the received line voltage and modify the line voltage by reducing the line voltage to a desired voltage. The grind controller 100 controls the RMS voltage by delaying an amount of time from each zero crossing of the supply voltage before allowing the supply voltage to be output to a load. As described in more detail herein, the controller 100 imposes a repeating on/off duty cycle that operates for prescribed on and off time periods and enables an overall timing or duration of the grind. This modified voltage is then fed to the motor of the rotating blade coffee grinder 110. Here, “line in” 112 is for the supply power from an ordinary house, or line, source that in the US is nominally 120 volts at 60 cycles/see, but may alternatively be any other common source used elsewhere. The line current in (“supply voltage”) 112 connects to the controller 100 that supplies the modified current (“adjusted voltage signal of the supply voltage”) as described herein to power the grind motor.

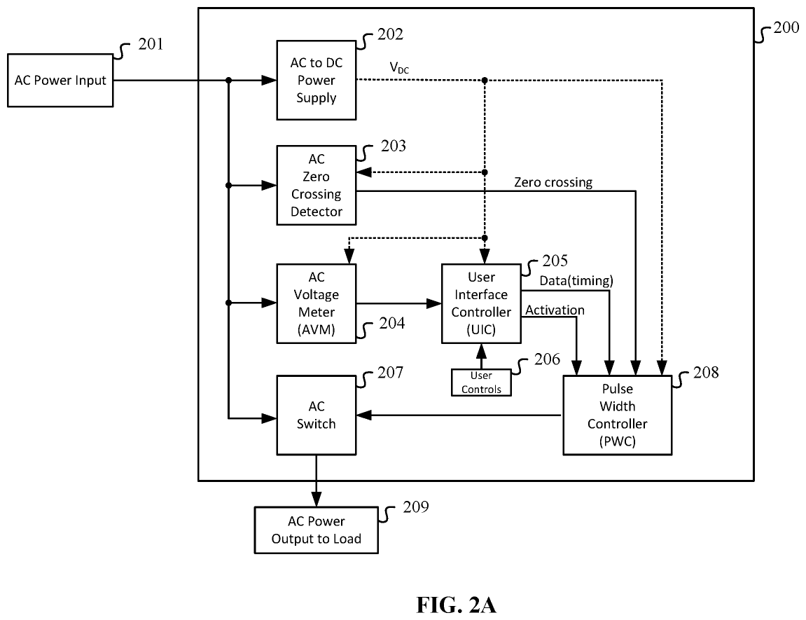

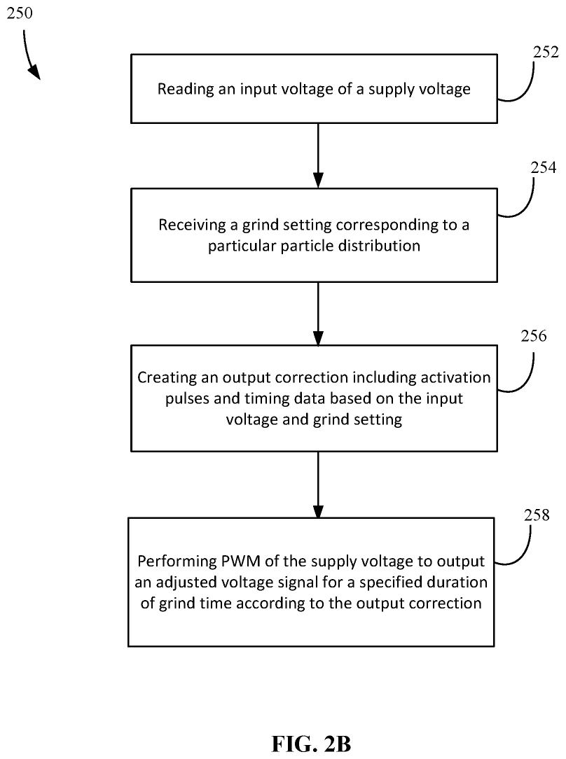

Controller 100 may be implemented as described with respect to controller 200 of FIG. 2A and the process 250 as described with respect to FIG. 2B. For example, controller 100 can include an AC zero crossing detector coupled to receive the supply voltage; an AC voltage meter coupled to receive the supply voltage; a user interface controller coupled to receive the grind setting and an output of the AC voltage meter, the user interface controller creating an output correction including timing data and activation pulses based on the output of the AC voltage meter and the grind setting; a pulse width controller coupled to receive the output correction from the user interface controller and a zero crossing signal of the AC zero crossing detector; and an AC switch coupled to receive the supply voltage and output the adjusted voltage signal under control of the pulse width controller.

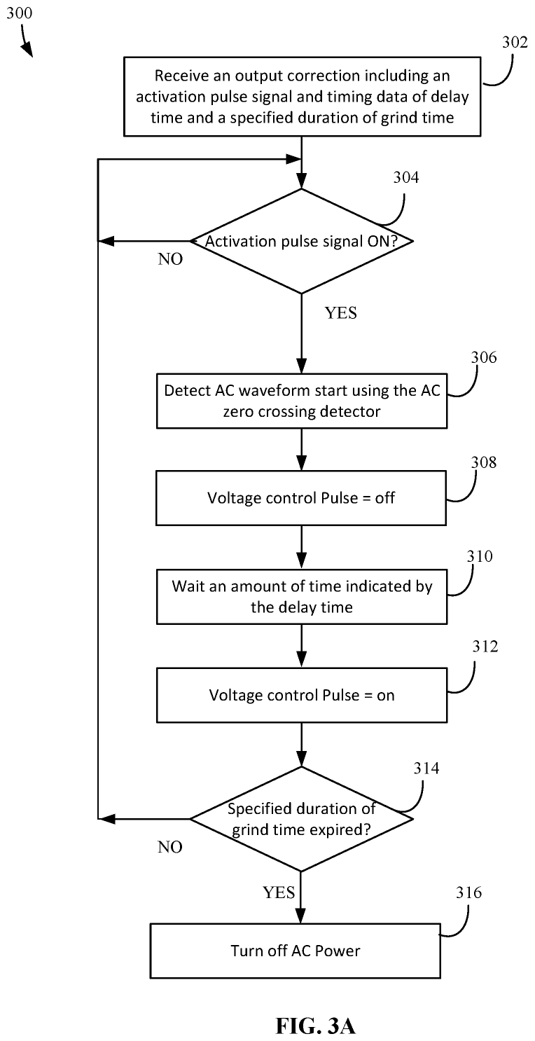

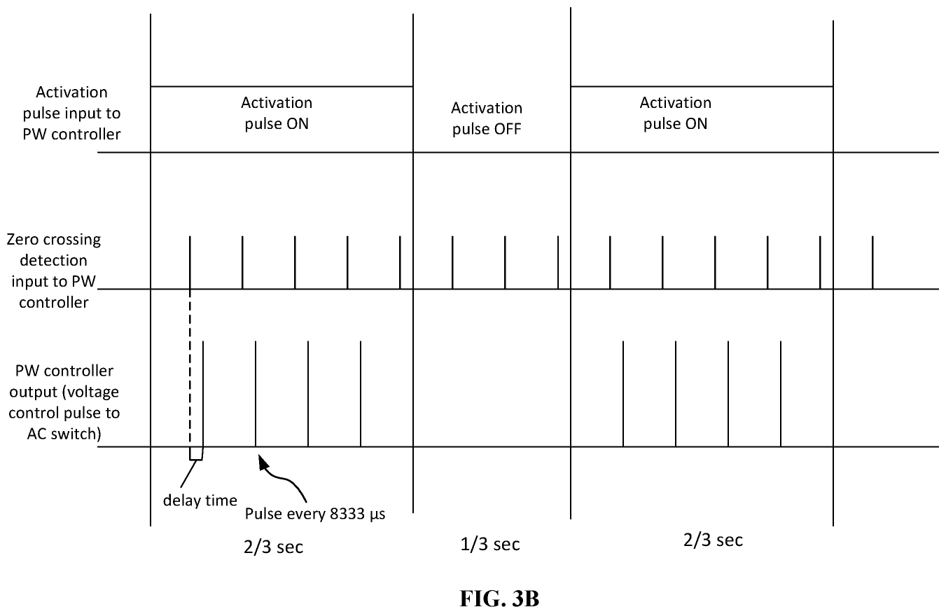

Controller 100 may perform the pulse width modulation process 300 as described with respect to FIG. 3A. In some cases, controller 100 includes a processing element, memory, and instructions stored in the memory that when executed by the processing element direct the controller 100 to perform the process 300.

As explained below, the controller supplies an adjusted voltage signal of the supply voltage in a manner that can address the challenges of rotating blade grinders on the grind products. The rationale for invoking these methods derives from the physics of fracture leading to mode development and properties of fluidized bed flow as applied to the interpretation of observations of the grind products of rotating blade grinders.

Modification of grinder power: At normal line voltage, regardless of the corresponding wattage ratings of the grinder motors, the grind quality is observed to be insufficiently controlled with either too little grinding or prominent production of ultrafine particles and dusts, and, in both cases, with no evident dominant mode between these largest and smallest particles. Introducing intermittency by interrupting the power (explained below) has little effect on the finest fraction of the grind though limited improvement in the size distributions are observed. However, utilization of means to control the speed of the motor was found to provide improvement in distributions. By reducing the RMS voltage, it is possible to reduce the speed of the rotating blades from the high speeds of typical rotating blade coffee grinding technology (e.g., 25,000 rpm to 35,000 rpm with no load) to a lower range (e.g., 4,000 rpm to 30,000 rpm), depending on desired grind setting/particle distribution.

Testing was conducted and showed that the required degree of line voltage reduction depended upon the quantity, as determined by bulk volume, of beans being ground. An additional consideration to the control algorithm is the volume and configuration of the batch grind container. In certain implementations, the actual line voltage at the time and location of use is taken into account for improved operation since variation in the range from 110 VAC to 130 VAC for the nominally standard 120 VAC is not uncommon. By taking into account actual line voltage when reducing the RMS voltage, it is possible to maintain a constant RMS voltage and not just provide a relative reduction.

Regular power interruptions: Persistence throughout the grind process of one or a small number of whole or minimally ground coffee beans is commonly observed in rotating blade grinders. This observation pertains regardless of brand, or even the power reductions discussed above and raises fundamental questions concerning fluidized bed grinding. Resolution of this question is assisted by description of the grind bed in a transformed coordinate frame where the blade is stationary and the particle bed is in rapid motion about the axis of rotation of the blade, as if carried by a circulating airflow. A picture that can then be adduced to explain this observation is the presence of an enveloping flow about an isolated larger particle by the much more numerous, small, “fluidized bed” particles. This fluid-like flow of the smallest particles moves the larger particle along the flow lines of the small particles around the blade(s) of the grinder, thereby avoiding collision and fracture. More generally, the fluidized bed flow interferes with the assumed preferential collisions and fracturing of the largest particles present at a given time during the operation of the grinder. By failing systematically to reduce in size all of the surviving largest particles, the development of a single mode in the resultant particle size distribution of the grind is undermined. In addition, uninterrupted grinding does not allow for heat to be dissipated from the grind bed, thereby conceivably raising the internal temperature of the grind beyond desirable levels.

A solution to these issues is to interrupt the power, or voltage, to the rotating blade's motor in order for the rotating fluidized bed to collapse sufficiently to break up the fluidized bed flow pattern that causes the problems discussed here, as well as to permit heat to escape rather than continuously accumulate within the bed. The sizes of the chambers where the rotating blades operate may also be considerations in these power interruptions as well as in the quantitative reduction of voltage or modification of grinder power discussed previously.

In mixing of granular materials by use of a rotating-blade mixer, the fluid-like, steady-state motion of the fluidized bed as described above may impede mixing of adjacent flow threads, or streamlines, comprised of differing materials. Interrupting this steady-state flow will accelerate the mixing.

Accordingly, activation pulses can be used to control the interruption of power to the motor, wherein the length of time of the activation pulses and the time between activation pulses can be optimized for disruption of the laminar flow while keeping overall duration of the grind (or mixing) to a desired length of time.

Grinding duration: During experiments, grind size distributions were measured and these measurements revealed dependences upon not only quantity but also upon the roast of the beans being ground, even with grinder motor power/voltage regulation and interruptions. It was found that by further controlling duration of the grind, it is possible for an optimal size distribution for a particular desired grind and roast to be realized.

Based on the above-mentioned observations, a controller and method can be used to achieve desired particle size distributions.

In various implementations, there are three elements that may be individually present, present in pairs, or all 3 simultaneously present, depending upon the operational parameters of the blade drive motor and configuration of the grind chamber of a specific rotating blade coffee grinder or other motor control application:
1. Control of the voltage, or more precisely the rms voltage in the case of alternating current, delivered to the motor driving the blade of a rotating blade coffee grinder, and therefore its rate of rotation. A specified voltage applied by the controller corresponds to the specific quantity of beans in a grind batch, the grind container, and the brew method in certain cases.
2. Interruption of the electrical power to the grinder motor for a specified length of time and spacing these interruptions over uniform intervals when the motor receives electrical power.
3. Limitations on the duration of the grinding operation corresponding to the quantity of beans being ground, their degree of roast, the intended coffee brewing method, and optionally the batch grind container.

In some cases, the controller modifies the line voltage by reducing the rms value of the line source to rms values that are determined by the quantity of beans being ground and the configuration of the container in which the batch grind takes place. In addition, or as an alternative, the controller can modify the voltage by interrupting it for a specified period of time after which the voltage regains its value prior to the interruption such that current resumes for the same or different specified periods of time with this sequence repeated for the entire duration of the grinding process. In some cases, the controller can modify the line voltage by limiting the overall duration of the grind process to a length of time that depends upon the quantity of beans being ground, their roast, and upon the intended brewing method.

FIG. 2A is a block diagram of a controller for a rotating blade commutation or mixing system described herein. Referring to FIG. 2A, controller 200 includes a low voltage power supply (VDC) 202 (e.g., to supply the necessary DC voltage such as 3.3V to the components of the controller), an AC Zero crossing detector 203, an AC voltage meter (AVM) 204, a user interface controller (UIC) 205, an AC switch 207, and a pulse width controller (PWC) 208. Controller 200 also includes an input interface for receiving user controls 206. The PWC 208 may also be the same or an alternate core in the UIC 205. For example, the user interface controller UIC 205 and the pulse width controller PWC 208 can be embodied as a single processing element executing appropriate instructions implementing the user interface controller and the pulse width controller.

On the diagram, AC Power Input 201 refers to the ordinary line or facility power source. AC Power Output to Load 209 is the modified, modulated voltage to the rotating blade coffee grinder motor, or motor driving other rotating blade device (e.g., the adjusted voltage signal of the supply voltage for activation of the motor based on the grind setting output to motor 135 of grinder 110). AC power from the AC Power Input 201 is received by the Low Voltage Power Supply VDC 202, the AC Zero Crossing Detector 203, AC Voltage Meter (AVM) 204, and the AC switch 207. The VDC 202 can provide the low voltage used by the AC zero crossing detector 203, the AVM 204, User Interface Controller 205, and Pulse Width Controller (PWC) 208.

The AC Zero Crossing Detector 203 can be any suitable AC zero crossing circuit, including those with or without photocouplers.

The AC Voltage Meter (AVM) 204 can include a commercial IC-based RMS integrated circuit that communicates the input voltage reading to the User Interface Controller (UIC) 205.

The UIC 205 (and PWC 208) can be one or more processing elements and may be implemented by a microprocessor as an example.

The UIC 205 receives user input (e.g., the grind setting) from user controls 206 and an output of the AC voltage meter to create an output correction (e.g., with timing data for delays used in reducing RMS voltage, duration of grind, and activation pulse timing) based on the output of the AC voltage meter and the grind setting. Other parameters can also be taken into consideration (and may be considered when considering grind settings). In some cases, the UIC 205 performs a look-up in an internal data structure to determine appropriate output correction for the PWC 208. In some cases, the UIC 205 calculates the PWM timing data for delays used in reducing RMS voltage using a pulse algorithm (described below). As shown in FIG. 2A, the output correction includes timing and activation. The activation signal can be considered an enable signal.

After the user has entered the relevant grind settings in the User Controls 206 and the UIC 205 is commanded to start the operation, the UIC 205 sends the PWM timing correction (e.g., timing data from the output correction) to the PWC 208 and commands the PWC 208 to control the AC switch 207 to send power to the Load 209 (e.g., as part of the activation).

The PWC 208 receives the output correction from the user interface controller UIC 205 (timing and activation) and a zero crossing signal of the AC zero crossing detector 203. The AC switch 207 receives the supply voltage and outputs an adjusted voltage signal under control of the pulse width controller PWC 208. For example, to provide the PWM-corrected RMS AC output voltage to the output at the Load 209, the PWC 208 detects the AC waveform start with the AC Zero Crossing Detector 203 and delays activating the AC Switch 207 until a specified delay time has passed at each zero crossing. The specified delay time to correct the RMS AC output RMS voltage can be calculated by a function that provides the microsecond delays needed to the PWM timing to correct the RMS output voltage based on the measured voltage from the AC Voltage Meter 204. As mentioned briefly above, this calculation can be performed in real-time or be pre-calculated and stored in the look-up table in internal storage.

FIG. 2B illustrates a method of operating a rotating blade grinder for performing electric motor-driven rotating blade comminution for a desired grind setting. Method 250 may be carried out by the controller shown in FIG. 2A. Referring to FIG. 2B, controller 200 includes circuitry configured to perform process 250, including reading (252) an input voltage from a supply voltage; receiving (254) a grind setting corresponding to a particular particle distribution; creating (256) a correction for the output (“output correction”) including activation pulses and timing data based on the input voltage and the grind setting; and performing (258) pulse width modulation of the supply voltage for a specified duration of grind time according to the output correction. The pulse width modulation is performed such that for each activation of a motor of the rotating blade grinder caused by a corresponding activation pulse of the activation pulses during the specified duration of the grind time, the adjusted voltage signal has a constant RMS voltage.

The process 250 is used to operate a rotating blade grinder (e.g., rotating blade coffee grinder 110 of FIGS. 1A and 1B) including a motor coupled to one or more blades. By adjusting the RMS voltage to the motor of the rotating blade grinder, it is possible to reduce an uninterrupted rotational frequency of one or more blades coupled to the motor to between 4,000 and 30,000 revolutions per minute according to the grind setting.

Reading (252) an input voltage from a supply voltage may include reading the input voltage of a supply voltage by a voltage meter, such as AVM 204 of FIG. 2A.

Receiving (254) a grind setting corresponding to a particular particle distribution may include receiving grind settings from the user, for example user controls 206 received by the UIC 205 of FIG. 2A through a user interface such as described with respect to FIG. 1C. The grind setting can include quantity, roast, and grind (e.g., drip, espresso, etc.).

Creating (256) the output correction can be performed at the UIC 205 of the controller 200 of FIG. 2A. In addition to the grind setting and input voltage, the output correction is based on/affected by the grinder itself since RMS voltages and grind time durations can differ among grinders so any voltage and timing data used in a controller can be calibrated for the particular grinder being used. In some cases, creating (256) the output correction includes calculating PWM timing and a specified duration of grind time. In some cases, the PWM timing (e.g., timing delay to be used by the PWC 208 for the PWM at AC switch 207 of FIG. 2A) is calculated using a pulse algorithm. To perform the pulse algorithm, UIC 205 specifies the rms voltage Vᵣₘₛ, for a particular, user-selected setting, which is less than the rms line voltage V_{L}, measured by the AVM 204. The amplitude, or maximum value, of the line voltage is Vₘₐₓ=(\sqrt{2})×V_{L}. Then, a routine calculation for the wave termination angle that gives Vᵣₘₛ in terms of Vₘₐₓ provides the relation:

$$4 π {( \frac{{V}_{rms}}{{V}_{max}} )}^{2} = 2 {θ}_{t} - sin ( 2 {θ}_{t} )$$

where θₜ is the phase angle at truncation of the voltage wave, i.e., where the voltage wave is set to 0. Thus, timing data of the output correction based on the input voltage and the grind setting can include performing a look-up of a corresponding RMS voltage Vᵣₘₛ for the grind setting and the specified duration of the grind time associated with the grind setting; and calculating a time delay pulse width modulation timing by solving for a closest truncation time to a wave termination angle θₜ given in the above relation.

For a 60 Hz wave, a discrete form of this equation is given by:

$$4 π {( \frac{{V}_{rms}}{{V}_{max}} )}^{2} = 2 π ( 1 - \frac{n δ}{8333} ) - sin ( 2 π ( 1 - \frac{n δ}{8333} ) ) .$$

Here, δ is an increment in time (in μs units) and n is the number of time increments subtracted from a full cycle of 8333 μs, or equivalently, the number of time increments following the zero-crossing when the voltage-wave amplitude is allowed to assume the amplitude that corresponds to its phase at that time. This equation is the basis for calculations of the time delay used for PWM (e.g., the PWM timing values that are used to wait before switching on or off), where the equation is rearranged leaving only Vᵣₘₛ on the left side of the equation and all other terms and factors on the right side. The procedure for determining the optimum value of n δ is then to evaluate the right side of the equation for successive, increasing values of n until it reaches its first value less than Vᵣₘₛ. In some cases, this (or the prior evaluation) is then the optimal solution of the time delay for PWM. As one example, with an increment δ=20 μs, line voltage V_{L}=110 VAC, and Vᵣₘₛ=90 VAC, the truncation time n δ=3440 μs (for n=172) gives PWM voltage of 90.043697 VAC while evaluating for n=173 gives a PWM voltage of 89.743642 VAC which in this case is within 0.3% of the desired value.

Voltage (or power) interruption duration is generally dependent upon the grinder configuration, the material being subject to grinding, and the time required for the apparent laminar flow of the grindings to partially collapse. In some cases, the on time for the PWM-modulated voltage of no more than one second on, followed by one second off is suitable. For example, for coffee beans in small, typical domestic rotating blade grinders, 0.333 seconds on followed by 0.167 seconds off may be suitable. An example timing is shown in FIG. 3B.

In some cases, creating (256) an output correction can include checking an internal database for a correct PWM timing (of pre-calculated time delays based on various desired RMS voltages and values of input line voltage) for the PWC 208 and checking the internal database for a specified duration to run the pulse operation (e.g., grind time).

Performing (258) pulse width modulation of the supply voltage includes delaying an amount of time, as indicated by the timing data, from each zero crossing of the supply voltage before allowing the supply voltage to be output to a load. The pulse width modulation can be performed (258) by, for example, a dedicated PWC 208 separate from the User Interface Controller 205 or using an extra core in UIC 205 to ensure precise timing is maintained from the beginning of an AC cycle at the zero voltage point until the desired PWM waveform starts. As mentioned above, the pulse width modulation of the supply voltage is performed during activation pulses. To accomplish this, the PWC 208 is commanded to activate the AC switch 207 on the calculated PWM timing (e.g., for RMS voltage adjustment) while the UIC 205 commands the PWC 208 to interrupt the output. In some cases, for each activation of a motor of the rotating blade grinder during the specified duration of the grind time, a pulse length of the activation pulse is less than five seconds. In some cases, the pulse length is less than one second.

FIG. 3A illustrates an example operation of the pulse width modulation controller shown in FIG. 2A for performing electric motor-driven rotating blade comminution for a desired grind setting. Referring to FIG. 3A, a controller (e.g., controller 100 of FIGS. 1A-1C, controller 200 of FIG. 2A) can perform pulse width modulation process 300, including receiving (302) an output correction including an activation pulse signal and timing data of a delay time (e.g., PWM timing) and a specified duration of grind time; determining (304) whether the activation pulse signal indicates to be on; while the activation pulse signal indicates to be on, creating a pulse for RMS voltage control (e.g., to control an AC switch) by detecting (306) the start of an AC waveform using the AC zero crossing detector; setting (308) the pulse as off; waiting (310) until an amount of time, as indicated by the timing data, has passed from the start of the AC waveform; and setting (312) the pulse as on after the amount of time has passed. The pulse can be on until a next zero crossing is detected or be a specified amount of time, which may be shorter than when the next zero crossing may occur. Multiple pulses may even occur before the next zero crossing. In addition, in some cases, the pulse creation occurs multiple times before continuing to the next step (e.g., so that 2, 3, 4, or more pulses are generated before checking grind time duration and/or activation pulse signal). The method further includes determining (314) whether the specified duration of grind time has expired and if “yes”, turning off (316) the AC power, and if “no” continue to repeat the process (e.g., operations 304, 306, 310, 312, 314). It should be understood that detection of the activation pulse is not required to be an active step. For example, the activation pulse may operate as an enable signal such that the pulse width controller is turned off and operations 306, 310, 312, and 314 are not performed unless the activation pulse is on.

The timing of the activation pulses may change during each cycle of on and off during the specified duration of grind time. However, in all cases, the timing values for activation of the motor/blades are less than 5 seconds.

FIG. 3B shows a timing diagram of an example output of the pulse width modulation controller. As described with respect to FIG. 3A, the pulse width controller receives an activation pulse signal, delay time, and duration of grind time. In the illustrated example, the activation signal is on for ⅔ second and off for ⅓ second. When the activation pulse signal is on (determine (304)=yes), the pulse width controller detects a zero crossing from the zero crossing detector, keeps output low (i.e., pulse=off (308)), and waits the delay time (310) before setting the pulse as on (i.e., pulse=on (312)). These voltage control pulse signals are output after waiting the delay time after each zero crossing. In the illustrative example, the pulse width controller generates pulses every 8333 μs.

In some cases, the activation pulse signal turns on and off the pulse width controller so that during the off cycle of the activation pulse signal, the pulse width controller is completely off. In some of such cases, the zero crossing detection is also not performed. In other cases, the zero crossing detection occurs regardless of operation of the pulse width controller.

FIG. 3B does not show duration of grind time; however, once the total grind time is accomplished (e.g., as achieved within activation pulse signal ON time), the power can be turned off and it is possible to provide a signal to a user interface indicating completion of grind.

As mentioned above, the controller supplies an adjusted voltage signal of the supply voltage in a manner that can address the challenges of rotating blade grinders on the grind products. The rationale for invoking these methods derives from the physics of fracture leading to mode development and properties of fluidized bed flow as applied to the interpretation of observations of the grind products of rotating blade grinders.

The subsequent figures are histogram graphs with ordinates giving the mass-fractional distributions of coffee grounds and the abscissas giving ranges of particle nominal diameters (dₚ) corresponding to sieve sizes employed in measuring and reporting size distributions. The sieves used in the illustrative measurements discussed here are given in Table 1.

TABLE 1
Sieves Used in Measurements

| Tyler: | (#10 Tyler) | (#14 Tyler) | (#20 Tyler) | (#28 Tyler) | Residue |
|---|---|---|---|---|---|
| ASTM: | #12(1.524 mm) | #16(1.168 mm) | #20(.762 mm) | #30(.584 mm) | |
| size | 1.651 mm | 1.168 mm | 0.833 mm | 0.589 mm | |

A customary measure of coffee grounds is the masses of the ground coffee captured on graded screens. In a single measurement of a grind, coffee grounds are passed through these screens arranged serially from coarsest to finest, followed by the capture of particles penetrating all screens. The masses of particles captured on each of the screens as well as those penetrating all screens are determined. Taken together, this information provides the size, or mass, distribution of the grind. Herein, the quantity of coffee beans subject to grinding is specified by gross volume, i.e., “cups” in US units, while measurements are of masses that are converted to percents.

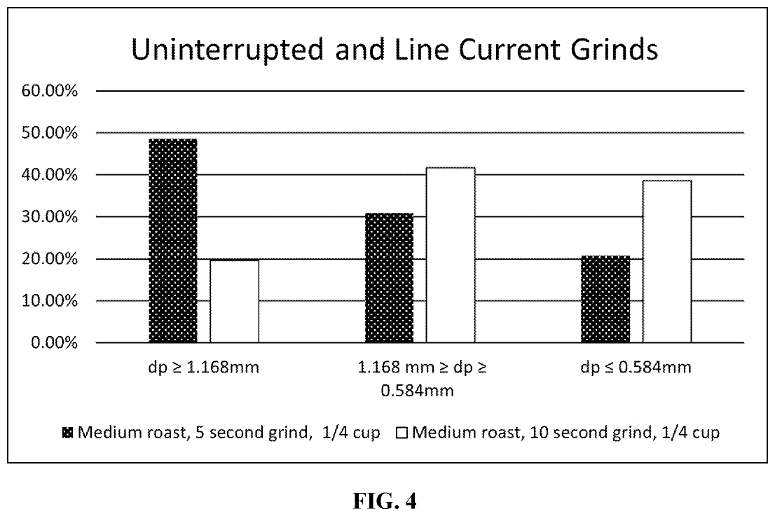

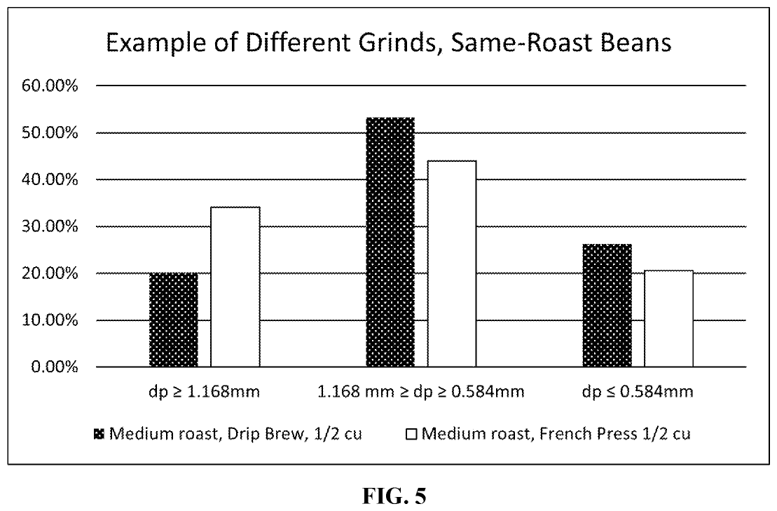

In Table 1, the boldface entries are the ASTM standard mesh sizes nearest to the openings, in parentheses, provided by the supplier of these meshes; the ASTM standard size is given below the ASTM sieve number. The closest corresponding Tyler screen is given in parentheses above the ASTM number. Finally, the Residue designation is for the particles that penetrate all sieve screens. Note that increasing sieve number corresponds to decreasing mesh, and therefore the particle size ranges given on the histograms' abscissas correspond to the particles that are captured by the sieves or that penetrate the final sieve (corresponding to the finest particles). In FIGS. 4, 5, and 6, the three mass-fractions displayed result from (1) summing the masses captured on sieves #12 and #16, (2) from summing masses captured on sieves #20 and #30, and (3) collection of the remaining particles. This presentation corresponds to the data format for the Standard North American Coffee Norms as discussed below.

FIG. 4 is a histogram of grinds size distributions from an unmodified grinder for two grind time intervals. The bars of this histogram display the fractional size distributions of identical samples of medium roast coffee grounds from a rotating blade coffee grinder operated without the controller for grind durations of 5 seconds and 10 seconds. In particular, FIG. 4 gives the mass-percentage size distributions of the grinds from an unmodified grinder for ¼ cup samples of coffee beans during 5 second and 10 second intervals of continuous grinding. Note that in the 5-second grind case, the greatest fraction of the grinds is in the largest fraction while in the 10-second grind case, the intermediate and small particle fractions are essentially equal.

FIG. 5 is a histogram of medium roast coffee size distributions ground with a controller for Drip and French Press brewing methods. Note the appearance of unmistakable modes.

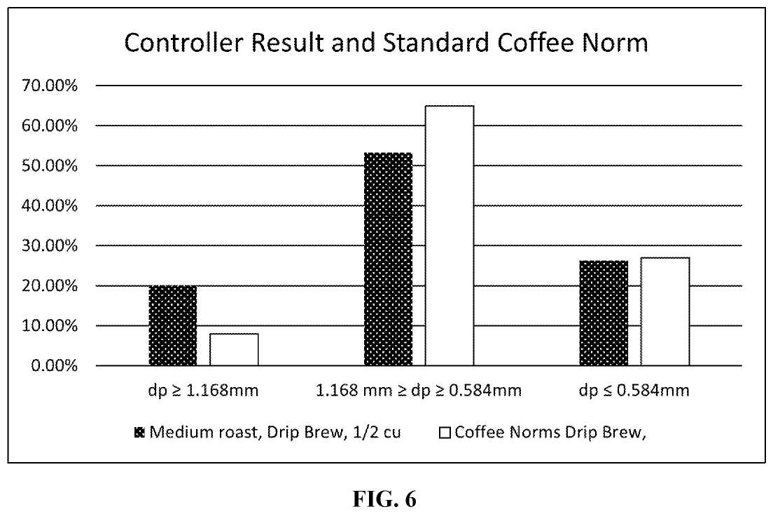

FIG. 6 is a histogram comparing Standard North America Coffee Norms for Drip grind and a Drip grind obtained using a prototype of the controller described herein. As can be seen from FIG. 6, a reasonable match to the Norms can be achieved with the methods described in this patent and is typical of the results found for the 33 cases developed here, including grinds for brewing espresso not encompassed by the sieves in Table 1.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A coffee grinder, comprising:
one or more blades;
a motor coupled to the one or more blades to drive rotation of the one or more blades; and
a grind controller that receives a supply voltage; receives a grind setting corresponding to a particular particle distribution; and controls RMS voltage, duty cycle, activation pulse frequency, and overall duration of a grind time of the supply voltage for activation of the motor based on the grind setting,
wherein the grind controller generates, from the supply voltage, an adjusted voltage signal of a constant RMS voltage that is supplied to the motor during activation pulses occurring during the overall duration of the grind time to complete operation of the grind setting.

2. The coffee grinder of claim 1, wherein each activation pulse has a pulse length of less than five seconds.

3. The coffee grinder of claim 2, wherein the pulse length is less than one second and time between pulses is less than one second.

4. The coffee grinder of claim 1, wherein the grind controller controls the RMS voltage by delaying an amount of time from each zero crossing of the supply voltage before allowing the supply voltage to be output to a load.

5. The coffee grinder of claim 1, wherein the one or more blades are mounted to an axis of rotation, wherein a plane of rotation of the one or more blades is perpendicular to the axis of rotation.

6. The coffee grinder of claim 1, wherein the grind controller comprises:
an AC zero crossing detector coupled to receive the supply voltage;
an AC voltage meter coupled to receive the supply voltage;
a user interface controller coupled to receive the grind setting and an output of the AC voltage meter, the user interface controller creating an output correction comprising timing data and the activation pulses based on the output of the AC voltage meter and the grind setting;
a pulse width controller coupled to receive the output correction from the user interface controller and a zero crossing signal of the AC zero crossing detector; and
an AC switch coupled to receive the supply voltage and output the adjusted voltage signal under control of the pulse width controller.

7. The coffee grinder of claim 6, wherein the grind controller further comprises:
an AC to DC power supply that receives the supply voltage and provides DC power to the AC zero crossing detector, AC voltage meter, user interface controller, and pulse width controller.

8. The coffee grinder of claim 6, wherein the user interface controller and the pulse width controller are embodied as a single processing element executing appropriate instructions implementing the user interface controller and the pulse width controller.

9. The coffee grinder of claim 1, wherein the grind controller comprises:
a processing element;
a memory; and
instructions stored in the memory that when executed by the processing element direct the grind controller to:
read an input voltage of the supply voltage;
receive the grind setting;
create an output correction comprising the activation pulses and timing data based on the input voltage and the grind setting; and
perform pulse width modulation of the supply voltage to output the adjusted voltage signal for the overall duration of the grind time according to the output correction such that for each activation of the motor caused by a corresponding activation pulse during the overall duration of the grind time, the adjusted voltage signal has the constant RMS voltage.

10. The coffee grinder of claim 1, further comprising:
a power cord, wherein the grind controller receives the supply voltage through the power cord.

11. The coffee grinder of claim 1, further comprising a grind controller package, wherein the grind controller package comprises a package power cord and an outlet shaped to receive a plug connector of a power cord of the coffee grinder, wherein the grind controller receives the supply voltage through the package power cord and supplies the adjusted voltage signal of the supply voltage through the outlet.

12. The coffee grinder of claim 1, further comprising a grind chamber that confines particles on all sides.

13. A method of operating a rotating blade grinder comprising a motor coupled to one or more blades, the method comprising:
reading an input voltage of a supply voltage;
receiving a grind setting corresponding to a particular particle distribution;
creating an output correction including activation pulses and timing data based on the input voltage and the grind setting; and
performing pulse width modulation of the supply voltage to output an adjusted voltage signal for a specified duration of grind time according to the output correction such that for each activation of a motor of the rotating blade grinder caused by a corresponding activation pulse of the activation pulses during the specified duration of the grind time, the adjusted voltage signal has a constant RMS voltage.

14. The method of claim 13, wherein performing the pulse width modulation of the supply voltage comprises:
delaying an amount of time, as indicated by the timing data, from each zero crossing of the supply voltage before allowing the supply voltage to be output to a load.

15. The method of claim 13, wherein each activation pulse has a pulse length of less than five seconds.

16. The method of claim 15, wherein the pulse length is less than one second and time between pulses is less than one second.

17. The method of claim 13, wherein creating the timing data of the output correction based on the input voltage and the grind setting comprises:
performing a look-up of a corresponding RMS voltage Vᵣₘₛ for the grind setting and the specified duration of the grind time associated with the grind setting; and
calculating a time delay pulse width modulation timing by solving for a closest truncation time to a wave termination angle θₜ given in the following relation:
$$4 π {( \frac{{V}_{r m s}}{{V}_{max}} )}^{2} = 2 {θ}_{t} - sin ( 2 {θ}_{t} )$$
where Vₘₐₓ is given by Vₘₐₓ=(√2)×V_{L}, where V_{L} is a measured line voltage of the supply voltage.

18. A grind controller comprising circuitry configured to:
read an input voltage of a supply voltage;
receive a grind setting corresponding to a particular particle distribution;
create an output correction comprising activation pulses and timing data based on the input voltage and the grind setting; and
perform pulse width modulation of the supply voltage to output an adjusted voltage signal for a specified duration of grind time according to the output correction such that for each activation of a motor of a rotating blade grinder caused by a corresponding activation pulse during the specified duration of the grind time, the adjusted voltage signal has a constant RMS voltage.

19. The grind controller of claim 18, wherein the circuitry comprises:
a voltage meter coupled to receive the supply voltage;
an AC zero crossing detector coupled to receive the supply voltage;
a user interface controller coupled to receive the grind setting and an output of the voltage meter, the user interface controller creating the output correction based on the output of the voltage meter and the grind setting;
a pulse width controller coupled to receive the output correction from the user interface controller and a zero crossing signal of the AC zero crossing detector; and
an AC switch coupled to receive the supply voltage and output the adjusted voltage signal during each activation pulse during the specified duration of the grind time under control of the pulse width controller.

20. The grind controller of claim 19, wherein the user interface controller and the pulse width controller are embodied as a single processing element executing appropriate instructions implementing the user interface controller and the pulse width controller.
